(19) United States
(12) Patent Application Publication
(10) Pub. No.: US 2024/0164416 A1
(43) Pub. Date: May 23, 2024

(54) Method And Device For Comminuting A Biological Process-Material

(71) Applicant: ELEA SERVICE GMBH, Quakenbruck (DE)

(72) Inventors: Robin Ostermeier, Osnabruck (DE); Stefan Toepfl, Osnabruck (DE); Kevin Hill, Osnabruck (DE)

(21) Appl. No.: 18/282,826

(22) PCT Filed: Mar. 17, 2022
(86) PCT No.: PCT/EP2022/057010

§ 371 Date: Sep. 19, 2023

(30) Foreign Application Priority Data
Mar. 23, 2021 (DE) 10 2021 107 188.7

(51) Int. Cl. A23L 5/30

(52) U.S. Cl. CPC A23L 5/30

(57) ABSTRACT

The present invention relates to a method for comminuting a biological process-material (2), the method comprising electroporatingthe biological process-material (2) and comminuting the electroporated process-material (2). The present invention also relates to a device (1) for the comminution of a biological process-material (2) using an electroporator (3) and a comminution device (4). In order to provide a method and a device for comminuting a biological process-material, which reduce the amount of waste and minimize yield losses, in the method according to the invention, a comminution parameter (ZK) is acquired and an electroporation parameter (EP) is set subject to the acquired comminution parameter (ZK). For this purpose, the device (1) according to the invention comprises a measuring device (5) for acquiring a comminution parameter (ZK) and a controller (6) for setting an electroporation parameter (EP) subject to the acquired comminution parameter ZK).

The present invention relates to a method for comminuting a biological process-material, including the steps of electroporating the biological process-material and comminuting the electroporated process-material.

The present invention further relates to a device for a comminuting a biological process-material, including an electroporator and a comminution device.

The comminution of a biological process-material, for example the cutting of potatoes into French fries, is known. For comminution, comminution devices with fixed knives may be used, as known from U.S. Pat. No. 5,058,478 B. In these comminution processes, a high proportion of rejects occurs, for example due to frayed or broken products.

In order to improve comminution, the process-material may be electroporated before comminution. Electroporation leads to a softening of the tissue, which favors the comminution process. However, electroporation may result in undesirable leaching and thus in yield losses of the process-material due to the release of cell ingredients, for example sugars and starch in the production of French fries.

Thus, it is the object of the present invention to provide a method for comminuting a biological process-material, while reducing the amount of rejects and minimizing yield losses.

The method according to the invention solves the problem by including the following steps:
Electroporating the biological process-material,
Comminuting the electroporated process-material, wherein a comminution parameter is acquired, and
Setting an electroporation parameter as a function of the acquired comminution parameter.

The device for comminuting a biological process-material according to the invention addresses this object by providing an electroporator, a comminution device, a measuring device for detecting a comminution parameter, and a controller for setting an electroporation parameter as a function of the acquired comminution parameter.

Electroporation of the biological process-material may promote its comminution. However, it has been found that electroporation with too low an intensity leads to an insufficient improvement in comminution, and overtreatment during electroporation leads to excessive comminution accompanied by yield losses. According to the invention, optimum comminution of the biological process-material is also achieved on industrial lines by acquiring a comminution parameter that is representative of the quality of the comminution. Depending on the acquired comminution parameter, the electroporation is adjusted. For this purpose, an electroporation parameter is set as a function of the acquired comminution parameter. For example, if the electroporation intensity is too low and the comminution is not yet in the optimal range, then an electroporation parameter may be adjusted to increase the intensity of electroporation. Conversely, if overtreatment occurs, in which too high a comminution parameter is acquired, an electroporation parameter may be set to decrease the intensity of electroporation.

In this way, electroporation may be coupled with comminution in such a way that the biological process-material is comminuted optimally and with a very low proportion of insufficiently comminuted products and minimized yield losses.

The present invention may be further improved with the following further variants and advantageous embodiments, each of which is advantageous in itself and may be combined with one another as desired.

In one embodiment, a momentum and/or a force that acts on the process-material during comminution may be acquired as a comminution parameter. It is also possible, alternatively or additionally, to detect as a comminution parameter a momentum and/or a force, which the process-material exerts on a comminution device for comminuting the process-material.

The comminution device may include a cutting device. The cutting device may have fixed or movable cutting edges. The movable cutting edges may be motor-driven.

To detect the comminution parameter, the measuring device may include a force meter and/or a momentum/pulsemeter. To determine a force or a momentum as a comminution parameter, the measuring device may alternatively or additionally include a velocity meter and/or an acoustic measuring device, e.g. a sound meter. The force meter may, for example, detect a torque in a cutting device with movable cutting edges. By means of such measuring devices, a comminution resistance, for example a cutting resistance and/or an applied comminution force may be determined. This cutting resistance reflects a certain momentum or force applied during comminution. A torque or a flow resistance, for example, may be determined as a comminution parameter.

Designs with a cutting device with stationary cutting edges may be used. In this case, a momentum or force acting on the stationary cutting edges may be determined as a size reduction parameter. This momentum or force may be detected by means of a load cell as a measuring device. In the case of a cutting device with stationary cutting edges, it is just as well possible to determine the flow velocity, with which the process-material passes the stationary cutting edges. Alternatively or additionally, an acoustic signal may be detected that characterizes the momentum, with which the biological process-material impinges on the stationary cutting edge. For example, a structure-borne sound measurement may be performed in the stationary cutting edges.

In a cutting device with moving cutting edges, for example, a torque may be determined. The torque may be determined at a drive that moves the cutting edges. Alternatively or additionally, a force occurring at the moving cutting edges may be detected as a comminution parameter. It is also possible to detect a structure-borne sound measurement in the moving cutting edges as a comminution parameter.

Also in other comminution types, for example in grinding, crushing, pulverizing, rasping, in which the comminution device may include a rasp, a mill, a pressing device or a grater, it is possible to detect as comminution parameter the force effect on an actuator and/or on a fixed or movable comminution element, and/or a structure-borne sound measurement of a comminution element.

According to a further embodiment, the controller includes a control unit for comparing the acquired comminution parameter with a comminution variable and for outputting a control signal setting the electroporation parameter. To this end, the acquired comminution parameter may be compared to a comminution variable, such as a value or range of values of the comminution parameter, and an actuating signal may be output as a function of the comparison. The comminution parameter may be stored in the controller, for example in its control unit.

For example, it has been found that a reduction in cutting resistance/cutting force of 0 to 50% may be achieved by means of electroporation on industrial lines during cutting. The degree of reduction depends on the electroporation parameters applied. One electroporation parameter that surprisingly correlates very well with cutting resistance reduction is the energy input in kJ/kg into the biological process-material. Surprisingly, it has been shown that a reduction in cutting resistance/cutting force in the range of 30 to 40% should be aimed for. A lower reduction in cutting resistance results in a poor size reduction appearance with a high percentage of inadequately size reduced or broken products. Overtreatment with too high a cutting resistance reduction leads to undesirable increased leaching of cell ingredients and thus to yield losses. In French fry production, for example, there is too high a release of sugars and starches, which has a negative effect on the quality of the end product.

In one embodiment, the comminution parameter for an untreated process-material may be acquired as a calibration variable or calibration size. An untreated process-material is a non-electroporated process-material. By means of this calibration parameter, the comminution value may be determined. For this purpose, for example, the calibration size may be converted into the comminution variable using a calibration modifier. The calibration modifier may be a calibration factor that is multiplied by the calibration size. For example, the calibration factor may be in the range of 0.55 to 0.75, preferably in the range of 0.6 to 0.7, so that the electroporation is controlled to a cutting force reduction in the range of 30 to 40%, thus achieving process-materials that may be comminuted particularly well.

Calibration of the device according to the invention or the method according to the invention may be performed both at the start of the comminution process and during operation. The comminution variablemay be determined at the beginning of the process, for example once when starting the processing of a batch of the biological process-material to be comminuted. The comminution variablemay also be determined during operation, i.e., in-line. Surprisingly, this enables continuous monitoring of optimally coordinated electroporation and comminution. The relevant parameters, i.e. the comminution parameters as well as the electroporation parameters, may be continuously monitored and the electroporation parameters may be adjusted accordingly.

The comminution parameter may preferably be determined in-line, which enables automation of the process or automated guidance of the device. The term in-line measurement refers to measurements that are integrated into the manufacturing process (line). The at least one measuring device may be, for example, a sensor or an in-line sensor, which is preferably capable of continuously determining the desired comminution parameters. The measured value may preferably be determined in-line, which enables automation of the process or automated guidance of the device.

During operation, the comminution variable may be determined repeatedly at predetermined time intervals, for example by switching off the electroporator for electroporating the biological process-material during operation for a predetermined calibration time, which could also be referred to as the calibration interval. As a result, untreated process-material is briefly fed to the comminution device and comminuted to determine the calibration size. In order to disturb the running operation as little as possible by a calibration, the calibration interval should be kept as short as possible. To ensure that the comminution parameter of the untreated process-material is actually determined as the calibration parameter, a delay interval caused by the transport time from the electroporator to the comminution device could be taken into account. Alternatively, an abrupt change in the comminution parameter that occurs when switching from treated, i.e., electroporated process-material to untreated, non-electroporated process-material could also be used as a start signal for recording the calibration parameter. After recording the calibration parameter, the electroporator may be reactivated and the process-material electroporated.

This type of in-line calibration may be performed once at the beginning of a comminutionprocess, i.e. when a process-material is applied. It is also possible to determine the comminution variable repeatedly at regular intervals during operation. Of course, it is also possible to determine the comminution variable offline, outside a production line, and to feed the calibration parameter or the comminution variable converted from it into the controller.

A possible mode of operation of a method according to the invention may include that first a comminution parameter, for example a cutting resistance of an untreated raw material, is determined as a calibration parameter. From the determined calibration parameter, a comminution variable is determined, which is to be aimed at during operation. Subsequently, the electroporator is switched on, whereby the electroporation parameters are set so that the system introduces the usual intensity, for example a certain energy input of, for example, 1 kJ/kg into the process-material. Subsequently, the comminution behaviour of the treated process-material is determined continuously or at regular time intervals based on a determined comminution parameter. Thereafter, the determined comminution parameter is compared with the previously determined comminution variable and, depending on the result of this comparison, the electroporation parameters are adjusted. In this way, continuous monitoring and online control is obtained, which optimally adjusts the intensity of electroporation to the comminution. As a result, as few rejects as possible occur during comminution.

A biological process-material is understood to be any kind of biological cells or organic materials, i.e. biomass in the broadest sense. The method according to the invention may be used for bioenergy production for industrial purposes, for example sugar production, bioethanol production, oil production, essential oil production, or starch production. It may be used for the treatment of plants or plant parts (for example, drying for seed, spice, tea, tobacco or herb production), or for the disruption of plant and animal cells or the production of food or food components. Food is essentially substances consisting of micronutrients that are consumed to nourish the human body. Macronutrients, i.e. carbohydrates, lipids/fats and proteins supply chemically bound energy to humans. According to one embodiment, the food product to be comminuted may be a raw vegetable product. For the purposes of the present invention, a raw product means an unpreserved food product. The raw product may be, for example, a potato, tuber, root, vegetable or fruit or fruits. The raw product may be selected from the group consisting of a tuber vegetable, a root vegetable, a legume vegetable, a pome fruit, a stone fruit and a shell fruit. According to one embodiment, the raw material may be selected from the group consisting of potatoes, sweet potatoes, pumpkin, parsnip, celery, carrots, cabbage, beet, chickpeas and corn.

Electroporation is a method of making cell membranes temporarily or permanently permeable. This technique is used, among other things, in microbiology to introduce DNA into cells. Electroporation is also used in the field of food and bioprocess engineering to improve mass transport processes or inactivate microorganisms. One advantage of electroporation is that it is a non-thermal process.

According to one embodiment, the electroporator may have at least two electrodes connected to a pulse generator. The electrodes, even if they do not have to come into direct contact with the medium to be treated, may preferably be made of stainless steel or titanium. The two electrodes form a capacitor and the space between the two electrodes forms the treatment chamber of the electroporator, in which the pulsed electric field is generated. The electrodes may be coaxial, collinear, conical or parallel to each other and generate a homogeneous electric field for uniform treatment of the medium. The pulse generator as a voltage source may be, for example, a high-voltage pulse generator, such as a Marx generator, which may be used to generate electrical pulses of high voltage in the kilovolt range and short duration in the microsecond to millisecond range. Different electrode shapes may be used in the capacitor. Plate, ring, grid, hollow, conical or flow-through electrodes are possible.

According to the invention, the conveying speed of a transported process-material and/or an operating parameter of the electroporator may be set as an electroporation parameter.

By selecting the electroporation parameters, a defined energy input of, for example, 1 kJ/kg may be made into the biological process-material. Depending on the application and the process-material, the energy input may be selected in such a way that the acquired comminution parameter is controlled to the comminution variable. In the case of the electroporator, for example, the strength of the electric field, the pulse shape, the number of pulses, the energy introduced, the pulse duration, the pulse frequency, the pulse voltage, the polarity, the current intensity, the specific energy and/or the treatment duration may be set as a possible electroporation parameter.

According to one embodiment, the device includes a conveyor section for transporting the process-material. The conveyor section may include a pipeline and/or a conveyor belt. Pipelines are suitable for handling pumpable process goods, for example potatoes in a process liquid. For solid process goods, a conveyor belt or screw conveyor may be used as the conveying section. The device may further include a drive for transporting the medium, for example a pump or a motor.

According to a further embodiment, the conveying speed of the medium is determined during transport through the comminution device. For this purpose, the device may include a speed meter for determining the conveying speed. The determined conveying speed may be determined as a comminution parameter.

The controllermay, for example, adjust the speed of the drive to set a desired conveying speed. The controller may be connected via a control line to the conveyor section or the drive and/or the electroporator, in particular its pulse generator. In the present invention, the determined parameters and/or the output control signals may be transmitted both wired and wirelessly, for example via signal lines or by means of radio technology.

In another embodiment, the device includes an energy measuring unit for determining the specific energy input into the medium during treatment with the pulsed electric field. For example, an oscilloscope may be used as the energy measuring unit. The energy measuring unit may determine the specific energy input as a function of the determined conveying speed and the operating parameters of the electroporator. If the energy measuring unit is coupled to the control unit, a closed control loop may be established, which ensures that either the conveying speed and/or the operating parameters of the electroporator are adjusted according to the control signal.

In the following, the invention is explained in more detail by means of advantageous embodiments with reference to the drawings. The advantageous further embodiments and designs shown are independent of each other and may be combined with each other as required in the application.

In the figures:

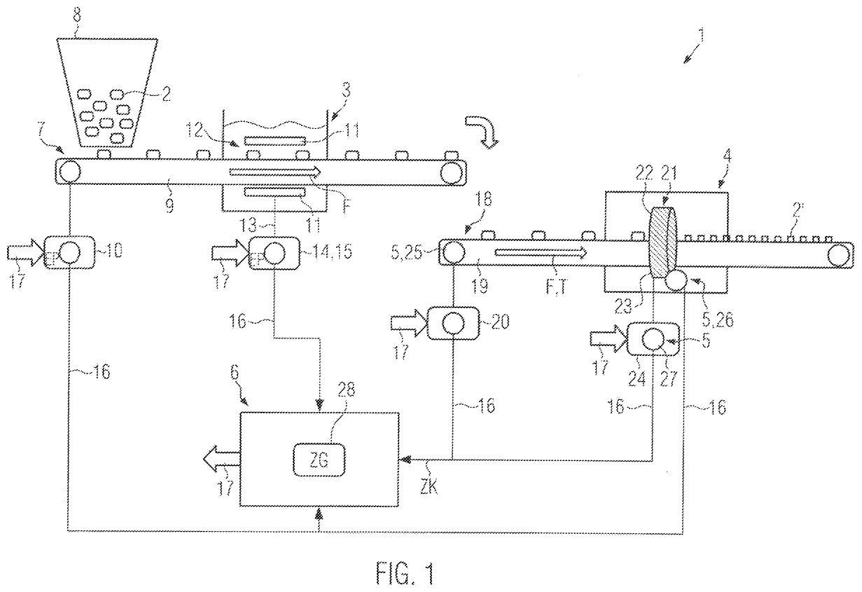

FIG. 1 is an exemplary embodiment of a device according to the invention for comminuting a biological process-material; and

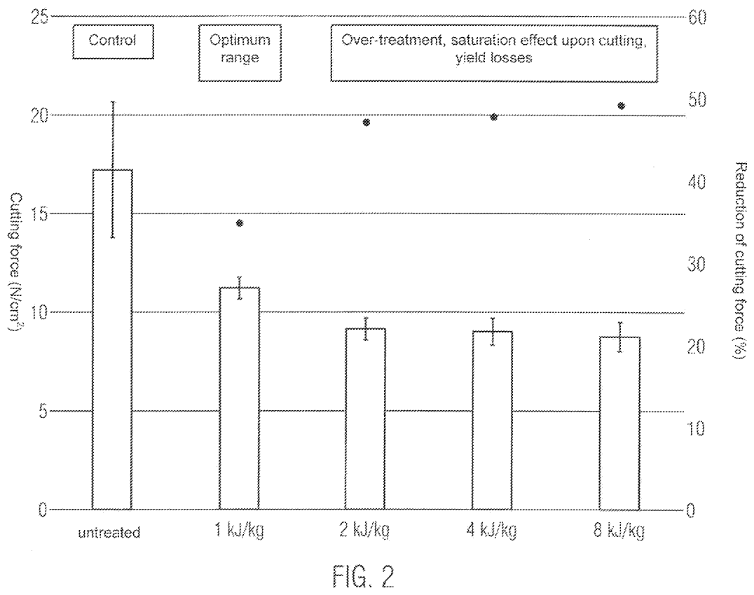

FIG. 2 is agraph showing the cutting force for an untreated and various treated process-materials in comparison to each other as well as the reduction of the cutting force of the electroporated process-materials.

In the following, an exemplary device 1 for comminuting a biological process-material 2 is presented with reference to the schematic representation of FIG. 1. In the context of this presentation, the method according to the invention for comminuting the biological process-material 2, which may be carried out, for example, with the device according to the invention, is also explained.

The device 1 shown in FIG. 1 includes an electroporator 3 for electroporating the biological process-material 2 (schematically shown by small rectangles) with a pulsed electric field. The device 1 further includes a comminuting device 4 for comminuting the process-material 2. The comminuted process-material 2′ is schematically shown in the form of small squares.

The device further includes at least one measuring device 5 for acquiring a comminution parameter ZK, and a controller 6 for setting an electroporation parameter EP depending on the acquired comminution parameter ZK.

In the embodiment shown, the device includes a first conveyor section 7 for transporting the process-material 2. The process-material 2 is metered onto the conveyor section 7 at one end of the conveyor section 7 via a feed device 8 and moved along the directions indicated by arrows. In the embodiment shown, the conveyor section 7 includes a conveyor belt 9 driven by a drive 10. Alternatively, the conveyor section 7 may include a screw conveyor or a pipeline in the case of a pumpable process-material. In the embodiment shown, the drive 10 may be a motor that moves the conveyor belt 9 at a defined conveying speed F.

The conveyor section 7 passes through the electroporator 3, or in other words, the electroporator 3 is arranged to treat a process-material 2 transported on the conveyor section 7 with a pulsed electric field. The electroporator 3 includes at least two electrodes 11 forming a capacitor 12 for generating an electric field in a treatment section of the conveyor section 7. The electrodes 11 of the capacitor 12 are connected to a voltage source 14 via power lines 13. In the embodiment shown, the two electrodes 11 of the capacitor 12 are arranged on opposite sides of the conveyor section 7 and parallel to each other. With such an electrode arrangement, a homogeneous electric field may be generated for uniform treatment of the process-material 2. However, other variants of the electrode arrangement are also conceivable, for example a coaxial, collinear or conical arrangement.

A pulse generator 15, for example a high-voltage pulse generator such as a Marx generator, which may be used to generate electrical pulses of a high voltage in the kilovolt range and a short duration in the microsecond to millisecond range, may be used as the voltage source 14. The electrodes 11 may be made of stainless steel or a titanium alloy, for example.

The exemplary system of FIG. 1 includes the controller 6 for setting an electroporation parameter EP. The electroporation parameter EP may be a conveying speed F of the transported process-material and/or at least one operating parameter of the electroporator 3. The electroporation parameter EP may be set such that a defined energy input [kJ/kg] from the electroporator 3 into the process-material 2 occurs. If the energy input is to be increased, for example, the conveying speed F may be reduced and/or the number of pulses or the strength of the electric field may be increased.

The controller 6 may be connected to the drive 10 via a control line (not shown; wireless in the exemplary embodiment), and in this way may adjust the conveying speed F of the transported process-material 2 on the conveyor belt 9 by controlling the drive. In the embodiment shown, the controller 6 is also connected to the electroporator 3 in a wireless signal-transmitting manner, and in this way may set, for example, the field strength, the pulse duration, the pulse frequency, the pulse shape, the pulse voltage, the current strength, and thereby control the specific energy input as electroporation parameter EP of the electroporator 3. The arrows, which are directed towards the actuator 10 or the electroporator 3, indicate that an actuating signal 17 may be output wirelessly, for example via a radio link from controller 6 to the actuator 10 or electroporator 3. Of course, wired control lines (not shown) may be used. Although not shown in FIG. 1, the data transmission may also be bidirectional, i.e., signals may also be transmitted from the drive 10 or electroporator 3 back to the controller 6. For example, the drive 10 may send a conveyor signal back to the controller 6 that is characteristic of the operation of the drive 10, for example the speed of a motor.

For all lines presented in the context of the present invention, it applies that these may be designed as wired and/or wireless connections and that signals or data may be transmitted via these lines not only in the direction indicated by arrows, but also in the opposite direction.

In the exemplary device 1 of FIG. 1, it is thus possible to control and regulate, via a setting of an electroporation parameter EP—for example, the conveying speed of the drive 10 or an operating parameter of the electroporator 3—the specific energy introduced by the electroporator 3 into the process-material 2 that is conveyed on the first conveying section 7 during its electroporation.

In the embodiment shown, the device 1 includes a second conveyor section 18 for transporting the electroporated process-material 2 to and through the comminution device 4. In the exemplary embodiment shown in FIG. 1, there are two separate conveyor sections, a first conveyor section 7, along which the electroporator 3 is located, and a second conveyor section 18, along which the comminution device 4 is located. However, there may also be a single continuous conveyor section (not shown) instead of the two separate conveyor sections 7, 18. The second conveyor section 18 in turn includes a conveyor belt 19 that may be moved by means of a drive 20 for transporting the process-material 2 to and through the comminution device 4.

The second conveyor section 18 runs through the comminution device 4, so that a comminuted process-material 2′ is present downstream of the comminution device 4 in the conveying direction T. In the exemplary embodiment, the comminution device 4 includes a cutting device 21. The exemplary cutting device 21 includes movable cutting edges 22. The movable cutting edges 22 may be arranged at the outer periphery of a drum 23 that is rotated by a motor 24. However, another cutting device 21 with stationary cutting edges (not shown) may be provided, which is arranged, for example, in a flow channel (not shown) as a second conveyor section, wherein the electroporated process-material 2 is transported in an aqueous medium through the cutting device with stationary cutting edges and is thereby comminuted. Both the drive 20 of the second conveying section 18 and the motor 24 of the cutting device 21 are connected to the controller 6 via control lines 16 in a signal-transmitting manner, as indicated by the arrows.

The exemplary embodiment of the device 1 shown in FIG. 1 includes a plurality of measuring devices 5 for acquiring a comminution parameter K. In the exemplary embodiment, a speed meter 25 is first provided for detecting the conveying speed, at which the process-material 2 is moved through the comminution device 4. Such a speed measuring device 25 is advantageous, for example, when a cutting device 21 with stationary cutting edges is used, wherein the process-material 2 is pumped through the cutting device 21 in a process medium through a pipeline. In this case, the speed, at which the process medium and thus the process-material 2 passes through the comminution device, may be a meaningful comminution parameter ZK, which allows conclusions to be drawn about the effectiveness of the electroporation and thus a statement about whether the intensity of the electroporation is within a desired operating range or outside the operating range. In the exemplary embodiment shown, the speed meter 25 is integrated in the conveyor belt 19.

In FIG. 1, a further measuring device 5, namely a force gauge 26, is present. This may determine the force exerted by the process-material 2 on the moving cutting edges 22, which may represent a further comminution parameter ZK in the sense of the present invention. It is also conceivable to have embodiments, in which the measuring device 5 is a pulse meter 27. In the embodiment shown, this pulse meter 27 may, for example, determine the torque of the motor driving the rotating cutting edges 22.

In the embodiment shown, the controller 6 includes a control unit 28 for comparing the comminution parameter ZK, which is acquired by a measuring device 5 and transmitted from this measuring device 5 to the controller 6, with a comminution variable ZG stored in the control unit 28. Depending on the comparison between the measured comminution parameter ZK and the stored comminution variable ZG, a control signal 17 for setting an electroporation parameter EP is output.

The comminution variable ZG thus represents a value or range in which the recorded comminution parameter ZK must lie so that the biological process-material 2 has been electroporated so well that the best possible comminution with little reject material is possible.

To determine the comminution variable, for example, the comminution parameter ZK for an untreated process-material may be acquired as a calibration variable. This calibration variable may then be converted into the comminution variable using a calibration modifier.

For example, it has been surprisingly shown that the cutting force to be applied for comminution of the process-material 2 in the comminution device 4 provides a reliable parameter for optimum electroporation with best possible comminution of the electroporated process-material. It has been found that when electroporating the process-material, the cutting force to be applied may be reduced by up to 50%, depending on the intensity of electroporation. However, the best possible cutting conditions are obtained in a range where the cutting force to be applied to the electroporated process-material 2 is 30 to 40% less than the cutting force to be applied to comminute an untreated, non-electroporated process-material 2 (see FIG. 2). In this respect, for calibration and determination of the comminution variable, one could first determine the cutting force for comminution of an untreated process-material 2. This would be the calibration parameter. Subsequently, one could multiply this calibration parameter by a calibration factor as calibration modifier, for example a calibration factor of 0.6 to 0.7, and convert it into the comminution variable, namely a reduction by 30 to 40% of the cutting force.

According to the invention, this calibration may be performed both at the beginning of a comminution process, i.e. as soon as process-material 2 is fed via the feed device 8 and moved directly and untreated through the cutting device 4 by the electroporator that is not yet active. However, it is also possible to determine the comminution variable ZG during the ongoing process, for example regularly at predetermined time intervals. For this purpose, the electroporator 3 may be switched off for a certain calibration time during operation. As a result, untreated raw material is transported to the comminution device 4 for a short time, by means of which the calibration parametermay be acquired. The time window of the calibration time may be narrowly dimensioned and the calibration variable for the untreated process-material may be specifically obtained by taking into account the time required for the transport from the electroporator 3 to the comminution device 4 on the basis of the conveying speeds F of the conveying sections 7, 18. Alternatively, a sudden increase of the comminution parameter ZK may be taken as an indicator that the calibration variable is detectable.

The mode of operation of the device 1 according to the invention, which is shown in FIG. 1, may for example proceed as follows: Process-material 2 is fed via the feed device 4 onto the first conveyor section 7 and is transferred along the conveyor section 7 by the electroporator 3, which is still switched off, onto the second conveyor section 18 and is comminuted along the transport of this second conveyor section 18 in the comminution device 4. During the comminution of this untreated process-material 2, a comminution parameter ZK, for example the cutting force, is detected as a calibration value and output to the controller 6. In the controller 6, this calibration value is multiplied by a calibration modifier and the result is stored in the controller as the comminution value or variable ZG to be aimed at. Subsequently, the electroporator 4 is activated and the comminution parameter ZK is acquired during operation for the electroporated process-material 2 during comminution. This comminution parameter ZK is output to the controller 6 via the control line 16. In the controller 6, the control unit 28 compares the acquired comminution parameter ZK with the stored comminution variable ZG. If the acquired comminution parameter ZK is within the targeted range of the comminution variable, the system may continue to run unchanged. If the acquired comminution parameter ZK is outside the targeted comminution variable ZG, for example because the cutting force is reduced too much, the controller 6 outputs a control signal 17. By means of this control signal 17, the intensity of the electroporation is reduced, for example by increasing the speed of the first conveyor section 7 or by reducing a parameter of the electroporator 3, for example the number of pulses or the strength of the electric field.

In this way, the electroporation of the process-material 2 may be continuously adjusted during operation to the desired comminution properties and a reject of comminuted process-material may be minimized.

### REFERENCE SIGNS

1 Device
2, 2 Process-material
3 Electroporator
4 Comminution device
5 Measuring device
6 Controller
7 First conveyor section
8 Feeding device
9 Conveyor belt
10 Drive
11 Electrodes
12 Capacitor
13 Power line
14 Voltage source
15 Pulse generator
16 Control line
17 Control signal
18 Second conveyor section
19 Conveyor belt
20 Drive
21 Cutting device
22 Cutting edge
23 Drum
24 Motor
25 Speedmeter
26 Force gauge
27 Pulse meter
28 Control unit
EP Electroporation parameter
F Conveying speed
T Transport direction
ZG Comminution variable
ZK Comminution parameter

1. Method for comminuting a biological process-material (2) comprising the steps:
Electroporating the biological process-material (2);
Comminuting the electroporated process-material (2), wherein a comminution parameter (ZK) is acquired; and
Setting an electroporation parameter (EP) as a function of the acquired comminution parameter (ZK).

2. Method according to claim 1, wherein a momentum and/or a force acting on the process-material (2) during comminution is acquired as comminution parameter (ZK).

3. Method according to claim 1, wherein, as comminution parameter (ZK), a momentum and/or a force is acquired, which the process-material (2) exerts on a comminution device (4).

4. Method according to claim 1, wherein the acquired comminution parameter (ZK) is compared with a comminution variable (ZG) and an actuating signal (17) for adjusting the electroporation parameter (EP) is output as a function of the comparison.

5. Method according to claim 4, wherein the comminution parameter (ZK) for an untreated process-material (2) is acquired as a calibration parameter to determine the comminution variable (ZG).

6. Method of claim 5, wherein the calibration parameter is converted to the comminution variable (ZG) with a calibration modifier.

7. Method according to claim 4, wherein the comminution variable (ZG) is determined at the beginning of the method.

8. Method according to claim 4, wherein the comminution variable (ZG) is determined while the method is being executed.

9. Method according to claim 8, wherein the comminution variable (ZG) is repeatedly determined at predetermined time intervals during operation.

10. Method according to claim 8, wherein the step of electroporating is suspended during operation for a predetermined calibration time and untreated raw material is cut so as to determine the calibration parameter.

11. Device (1) for comminution of a biological process-material (2), comprising an electroporator (3), a comminution device (4), a measuring device (5) for acquiring a comminution parameter (ZK), and a controller (6) for setting an electroporation parameter (EP) as a function of the acquired comminution parameter (ZK).

12. Device (1) according to claim 11, wherein the comminuting device (4) comprises a cutting device (21).

13. Device (1) according to claim 12, wherein the cutting device (21) comprises fixed or movable cutting edges (22).

14. Device (1) according claim 11, wherein the measuring device (5) comprises a force meter (26), a sound meter, a speed meter (25) and/or a pulse meter (27).

15. Device (1) according to claim 11, wherein the controller (6) comprises a control unit (28) for comparing the acquired comminution parameter (ZK) with a comminution variable (ZG) stored in the control unit and for outputting an actuating signal (17) adjusting the electroporation parameter (EP).

16. Method according to claim 2, wherein, as comminution parameter (ZK), a momentum and/or a force is acquired, which the process-material (2) exerts on a comminution device (4).

17. Method according to claim 9, wherein the step of electroporating is suspended during operation for a predetermined calibration time and untreated raw material is cut so as to determine the calibration parameter.

18. Device (1) according claim 12, wherein the measuring device (5) comprises a force meter (26), a sound meter, a speed meter (25) and/or a pulse meter (27).

19. Device (1) according claim 13, wherein the measuring device (5) comprises a force meter (26), a sound meter, a speed meter (25) and/or a pulse meter (27).

20. Device (1) according to claim 12, wherein the controller (6) comprises a control unit (28) for comparing the acquired comminution parameter (ZK) with a comminution variable (ZG) stored in the control unit and for outputting an actuating signal (17) adjusting the electroporation parameter (EP).
